(19) United States
(12) Patent Application Publication
(10) Pub. No.: US 2003/0160547 A1
(43) Pub. Date: Aug. 28, 2003

(54) Cold vault shelving system

(75) Inventor: Denis Paul Desrochers, Mississauga (CA)

Correspondence Address: Charles N.J. Ruggiero, Esq., Ohlandt, Greeley, Ruggiero & Perle, L.L.P., 10th Floor, One Landmark Square, Stamford, CO, 06901-2682, US

(73) Assignee: CDA Industries, Inc.

(21) Appl. No.: 10/083,786

(22) Filed: Feb. 26, 2002

(51) Int. Cl. B61B 1/00; B65G 1/00; E04H 3/00; A47F 3/04; F25D 11/00

(52) U.S. Cl. 312/116; 186/54

(57) ABSTRACT

There is provided a shelving system for a confined space. The system has a first shelf support frame with stationary upright columns, horizontal and transverse first frame bars between the columns, rear first shelf bars that can extend between the columns with attachments at opposite ends engageable with the first stationary columns. The system also has at least two second moveable shelf support frames made up of respective moveable front and rear columns, horizontal and transverse frame bars extending between the moveable front and rear columns, front shelf bars that extend between the moveable front columns and rear columns, and attachments at opposite ends of the front shelf bars, which are interengageable with the second moveable columns.

### BACKGROUND OF THE INVENTION

1. Field of the Invention

This invention relates to a storage shelving system, such as may be used in cold vaults used for storing products, usually though not exclusively in a retail store. More particularly, this invention relates to a storage shelving system for use in such a cold vault, which is adapted to contain large volumes of products in inventory and which is easily accessible for loading and for transferring products from a storage shelf to a point of sale display at the front of the cold vault.

2. Description of the Prior Art

Cold storage of a large inventory of products for sale is desirable in many situations, and especially in retail stores. The greater the volume of inventory that can be safely stored for a length of time, the lower the cost of delivery to each store. The deliveries can be spaced further apart, resulting in economies in the scheduling of drivers and vehicles. Operations at the retail store can also be coordinated for greater efficiency. However where large inventories are stored, it is desirable that they shall be readily accessible, to the store personnel, so that the actual point of sale shelves can be restocked from inventory easily, as and when product on display becomes depleted. As well as all these considerations it is clearly desirable that the cold vault shall occupy a minimum of floor space, and shall be as compact as possible, for a given volume of inventory to be stored, so as to maintain operating and cooling costs to a minimum. Safety of personnel is another important factor. Product especially cold beverage products such as soft drinks, and beer, are packaged in cartons which when fully packed represent a substantial weight, and may require careful handling, in the confined space of a cold vault.

Another factor is the flexibility of the shelving system itself. Sometimes, if the product is all of one kind and brand, the cases may simply be stacked with one case on top of another. In another instance, where different brands of product are stored, the cases may have to be stored on separate shelves so as to render them more accessible. Some product may be stored with the cases horizontally. Other products may be stored with the cases at an angle. This will render it easier for personnel to transfer product from a case in inventory over to the in store display racks at the point of sale.

Preferably, the shelving system will have sufficient flexibility that it can be readily rearranged to suit varying conditions and requirements by the store personnel themselves without the use of special tools.

The invention may also have application for providing compact accessible storage, whether in a cold vault or in any other location, whether cold or not, and whether in a retail store, or elsewhere.

### SUMMARY OF THE INVENTION

It is an object of the present invention to provide a space saving shelving system for storage of product in a confined space and providing ready access to such product for transfer of product from the shelving to another location. The system has a fixed shelf support frame having at least four stationary upright columns, arranged in pairs of respective stationary front and rear columns. Said fixed shelf support frame is adapted to be secured in a predetermined location within said confined space, horizontal stationary frame bars extending between said stationary front and rear columns in each said pair transverse stationary frame bars extending between said stationary front columns and between said stationary rear columns, said columns and said horizontal bars and said transverse bars defining together a generally rectangular storage space and at least two moveable front shelf support frames adapted to be located closely spaced from and parallel to said fixed support frame. Each said front support frame comprises two pairs of respective moveable front and rear columns, horizontal moveable frame bars extending between respective moveable front and rear columns, transverse moveable frame bars extending between said moveable front columns and said moveable rear columns, stationary shelf bars dimensioned to extend between said stationary front and rear columns, and moveable shelf bars dimensioned to extend between said moveable front and rear columns, and, attachment devices secured at opposite ends of said stationary and said moveable shelf bars, said attachment devices being interengageable with said moveable columns.

It is another object of the present invention to provide a space saving shelving system wherein said confined space is a cold vault for cold storage of said product, said cold vault having at least one wall and wherein said stationary shelving is located against a said wall of said cold vault.

It is another object of the present invention to provide a space saving shelving system wherein said stationary columns and said moveable columns are formed with slots at spaced intervals, said attachment devices being interengageable with said slots.

It is yet another object of the present invention to provide such a space saving shelving system and including a track for said moveable shelf support frames and fastening devices for securing said track to a substrate, and gliders on said moveable shelf support frames received on said track for permitting movement of said moveable shelf support frames along said track whereby to give access to said stationary shelf support frame.

It is another object of the present invention to further provide a cold storage vault for storing products at reduced temperatures and having a sales area with display racks accessible for removal of product for purchase, and having storage area for cold storage of additional inventory of said product, and having vault walls defining said cold storage vault, at least one of said walls having a service door for access to said storage area, and another of said walls having at least one sales access door, and, a space saving shelving system for storage of product located in said storage area of said cold vault providing ready access to such product for transfer of product from said shelving to another location, substantially as described.

### BRIEF DESCRIPTION OF THE DRAWINGS

Other and further objects, advantages and features of the present invention will be understood by reference to the following specification in conjunction with the accompanying drawings, in which like reference characters denote like elements of structure and:

FIG. 1 is a schematic representation of in store point of sale display cold vault illustrating the invention;

FIG. 2 is a top plan of both the display shelving and the inventory shelving, in the vault of FIG. 1;

FIG. 3 is an end elevation of the inventory shelving of FIG. 2;

FIG. 4 is a front elevation of a sliding shelf support for the inventory shelving;

FIG. 5 is an exploded view of a shelf support column, for the inventory shelving;

FIG. 6 is a sectional view along line 6-6 of FIG. 2 showing the rollers and track for the sliding shelving supports;

FIG. 7 is a perspective of a form of inventory shelving support;

FIG. 8 is a side elevation of the inventory shelving support of FIG. 7;

FIG. 9 is a schematic side elevation showing stacking of individual bulk cases of product;

FIG. 10 is a schematic side elevation showing stacking of tilted cases of product, spaced apart, and each case being accessible; and,

FIG. 11 is a schematic side elevation showing stacking of separate groups of bulk cases of product.

### DETAILED DESCRIPTION OF THE INVENTION

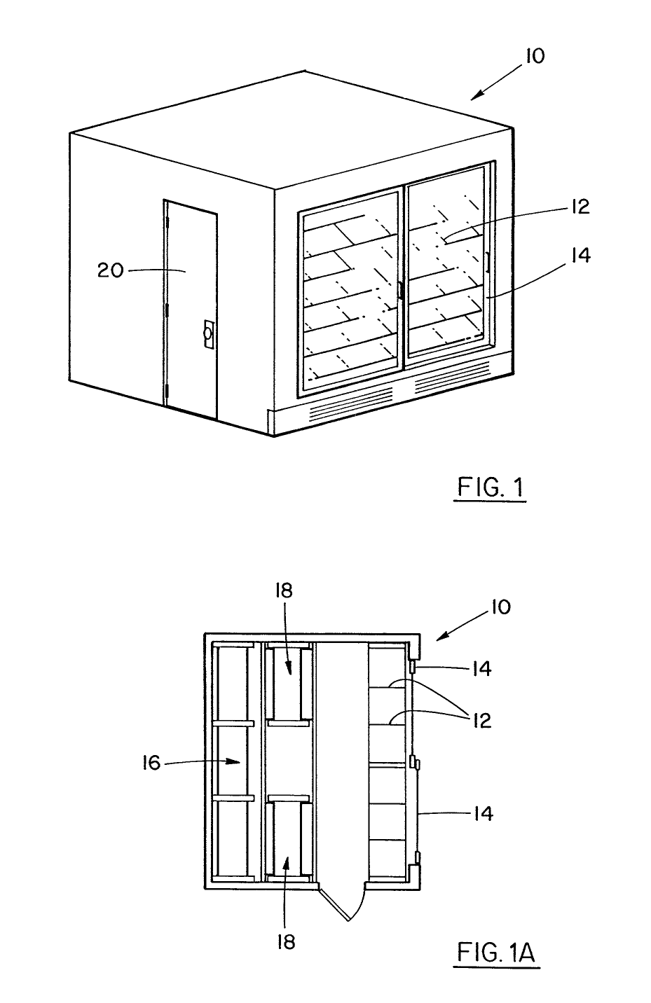

Referring to FIG. 1, it will be seen that the invention is illustrated in the form of an in-store cold vault indicated generally as reference numeral 10. Such a cold vault 10 serves both as a point of sale display, where chilled products are available for selection by a customer, and also as an inventory storage, where large quantities of product usually packaged in cases, can be stored, in the chilled atmosphere of the vault. Within the cold vault chilled product can be transferred from the storage shelves in the vault, to the display racks in the same vault, as product becomes depleted from the display, by customers removing product from the display, which they then purchase.

Such cold vaults are in wide use in retail stores, although in most cases all that the customer sees in the store is the display portion of the cold vault.

The inventory storage portion is simply not visible to the customer.

However, in most stores the staff have access to the cold vault through a door at the side of the vault, which is concealed from the customer.

While of particular application to cold vaults, the invention is not to be assumed as being confined solely to such locations, but is of application to any situation where shelving for storage of product or articles, in a compact and accessible manner, is required.

Accordingly, FIG. 1 illustrates in a general way, the vault 10, defined by, in a typical case, four walls, and having front display racks or shelves 12. In the front wall there will be the usual sales access doors 14. Customers may open the doors and remove product from the display racks, within the vault, which they wish to buy.

As will be seen in FIG. 1, within the vault, but behind the display racks 12, there are inventory shelves, namely a fixed rear inventory shelf system 16 and front sliding inventory shelves 18.

The inventory shelves are accessible through a service door 20. Normally this service door is located in one side wall of the vault concealed behind a wall enclosing the customer area of the store (not shown), and is accessible only to store staff.

There is a narrow walkway W located in the space between the display racks 12 located at the front of the vault, and the sliding shelves 18, which are located, together with the fixed shelves 16, towards the rear of the vault 10. Usually the fixed or stationary shelves 16 will be located closely adjacent the rear wall of the vault, for the sake of convenience. However, this arrangement is not a limiting feature of the invention. The inventory shelving might be located in a free standing location anywhere where storage is required, whether in the confined space of a cold vault or otherwise. There will usually be a system of sliding panels (not shown) at the back of the display racks 12 so that the customers cannot see the inventory storage area or the rear area of the vault at all.

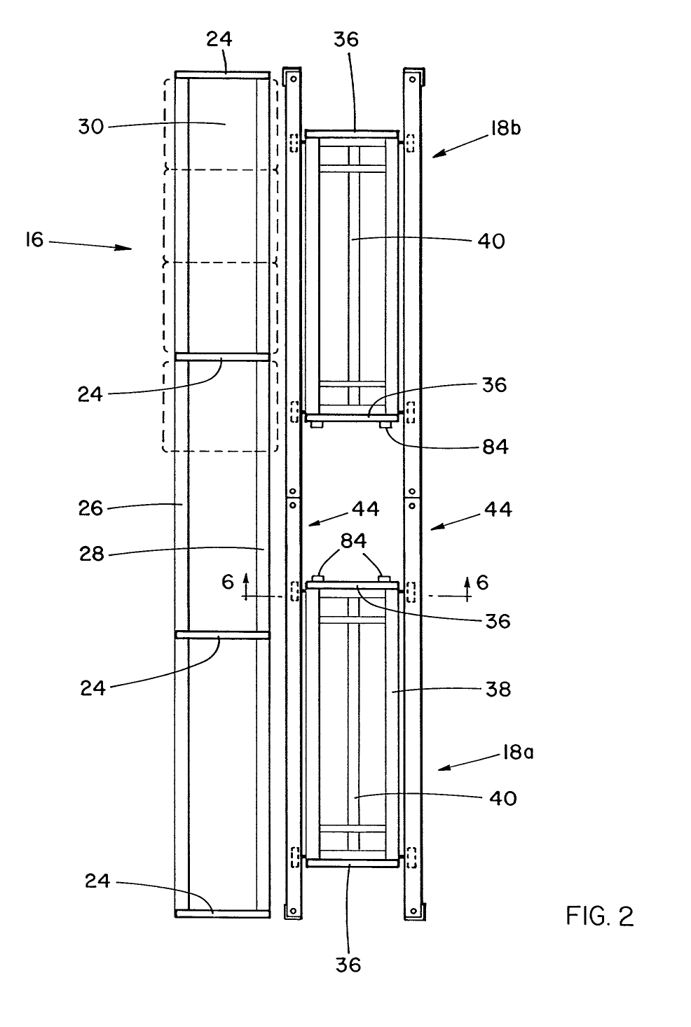

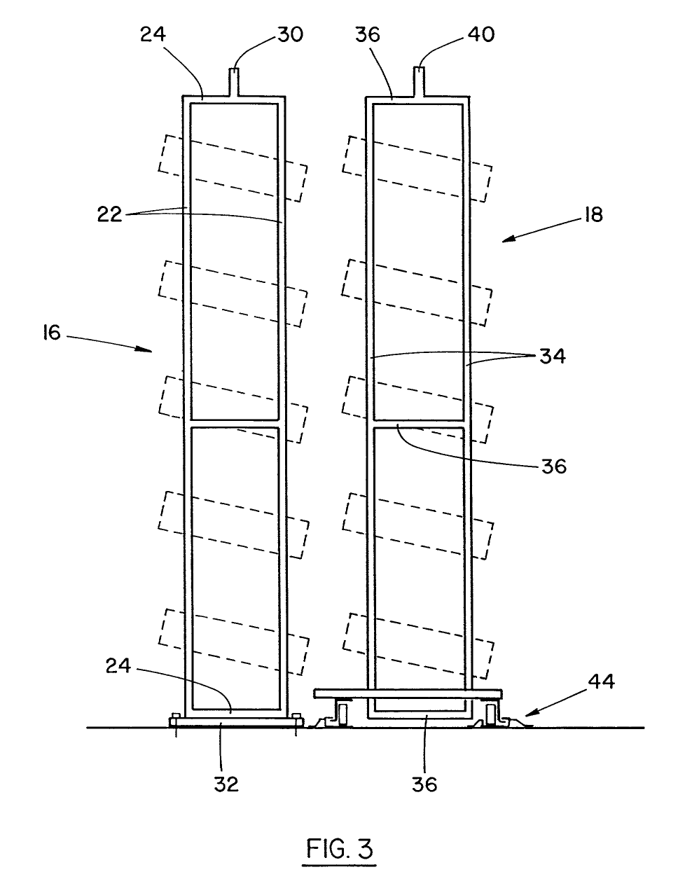

Referring to FIGS. 2 and 3, it will be seen that the inventory shelves are illustrated in the form of the rearward, first, fixed or stationary shelves 16, and forward second, or moving shelves 18.

This provides two rows of shelving, which is considered adequate for most such vaults. Conceivably two rows of second moving shelves could be provided, one in front of the other, as well as the rearward first fixed shelves. However, few users would require so much cold vault storage.

The rearward first stationary inventory shelves 16 comprise a rectangular first framework having at least four vertical columns 22, located with at least two first columns at the front and two first columns at the rear, at spaced intervals thereby defining a hollow rectangular enclosure. Horizontal upper and lower first end frame bars 24, join the front vertical columns 22 to the rear vertical columns, at their upper and lower ends. Transverse first cross frame bars 26 join the rear vertical columns 22 at their lower ends. Similar transverse first cross frame bars 28 join the front vertical columns at their lower ends.

A single overhead first frame bar 30 extends between upper end frame bars 24. First base bars 32 are secured to the lower ends of vertical columns 22 and extend forwardly and rearwardly (FIG. 3). They are secured to the floor by means such as concrete lag bolts or the like (not shown).

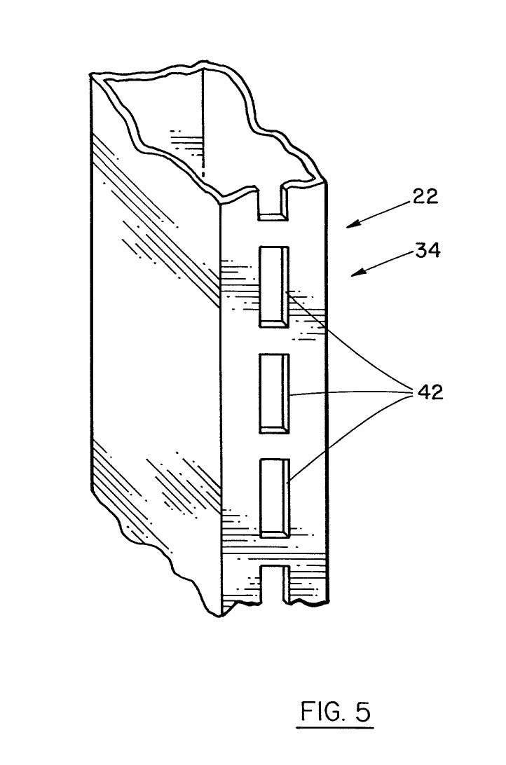

Vertical columns 22 are formed of rectangular metal tubes, described below, (FIG. 5).

The second forward, sliding inventory shelves 18 are formed from similar components as rearward first shelves 16. There are two such second moveable shelves indicated as 18a and 18b.

As mentioned above, conceivably there could be more such moveable shelves although this is not required in most cases. Each of the two second moveable shelves 18a and 18b is of similar construction, and comprises four second vertical columns 34, located at the corners of a rectangle, two of the columns 34 being located at the front and two columns at the rear. Upper and lower second horizontal end frame bars 36 extend between front and rear columns 34. Lower second transverse frame bars 38 extend between the two front columns 34 and between the two rear columns 34.

An overhead second frame bar 40 extends from the median of upper end frame bar 36 to the median of the other of upper end frame bars 36. The columns 34 are formed of rectangular metal tubes, and is the case of the first shelves 16. The tubes are slotted at slots 42 as shown in FIG. 5. Preferably, the slots 42 face forwardly although this is not critical.

The columns 34, bars 36 and bars 38, and overhead bar 40 of second moveable shelves 18a and 18b, thus define two hollow rectangular second spaces or enclosures, similar to the first stationary or fixed shelves 16.

Each of second moveable shelves 18a and 18b are slidable from side to side along a track indicated generally as 44. In this way by sliding shelves 18 to one side or the other, the rearward first stationary or fixed shelf 16 is rendered accessible, for loading and unloading product.

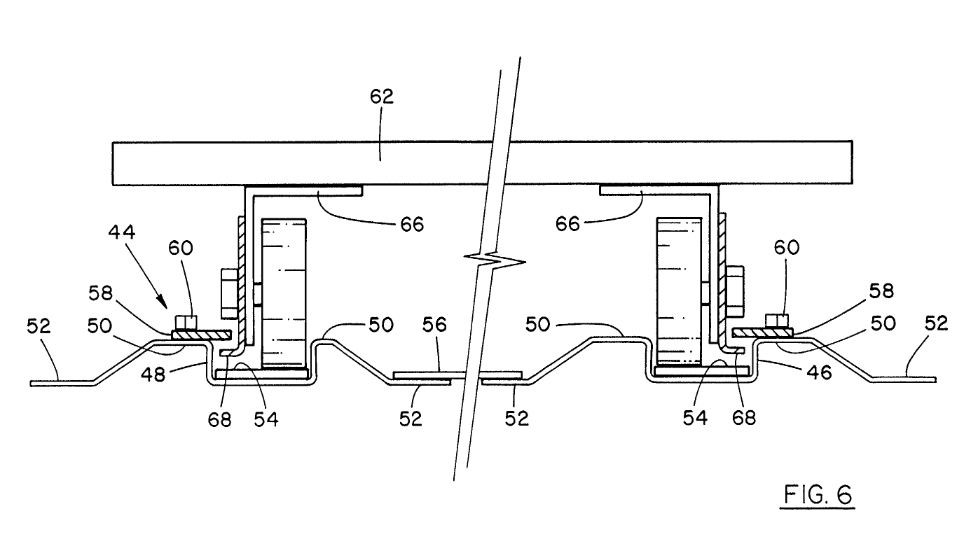

Track 44 is shown in more detail in FIG. 6. It comprises a front channel 46 and a rear channel 48. Each channel has shoulders 50 raised above a floor, and feet 52, which can be secured to a floor by lag bolts or the like (not shown). Preferably, an anti-friction slide member 54 is placed in each channel 46 and 48 to provide for free running without lubrication. The front and rear channels 46 and 48 are joined by a spacer plate 56, extending therebetween. The two channels and the plate may of course be made integrally, in one piece, if desired. Anti-tipping flanges 58 are removably and adjustably secured to the front shoulder 50 of front channel 46 and the rear shoulder 50 of rear channel 48, by bolts 60, for reasons described below.

Roller support bars 62 are secured between front and rear columns 34, and extend forwardly and rearwardly relative to such columns. Rollers 64 are mounted in L-shaped brackets 66, secured to the undersides of support bars 62 Lips 68 extend in front and rear directions from brackets 66. Lips 68 are dimensioned to slide under anti-tipping flanges 58. If a shelf 18a or 18b is loaded in such a way that it is off-balance, it may try to tip over. This is prevented by engagement of lips 68 with flanges 58.

Various different shelf systems can be mounted on first stationary shelf 16 and on second moveable shelves 18a and 18b. However, for reasons of economy and simplicity in manufacture, a single shelf system is illustrated here, which will fulfil various different functions satisfactorily.

Thus, FIGS. 7 and 8 illustrate identical front and rear shelf bars 70. The tray bars 70 comprise right angle section structural steel angle stock 72 having mounting brackets 74 secured, e.g. by welding, at each end. Brackets 74 are of an unequal channel shaped formation, having a face plate 76, an angle flange 78 at right angles to face plate 76, and fingers 80, oriented at right angles to angle flange 78. Fingers 80 are oriented to be received in slots 42 of the rear shelf columns 22 or the front shelf columns 34.

The L-shaped angle section structural steel angle stock 72 defines a right angle in section (FIG. 8). The face plates 76 are secured to opposite ends of the structural steel angle stock with the right angle configuration of the structural steel angle stock deliberately rotated a few degrees. This provides the bars 70 with greater strength and load bearing capacity.

It also locates the load bearing point at the apex of the right angle of the structural steel angle stock 72.

This point is offset somewhat rearwardly of angle flange 78. In this way, the load on the bar 70 is transmitted directly to the fingers 80, and avoids any tendency for the fingers to be rotated forwardly or backwardly.

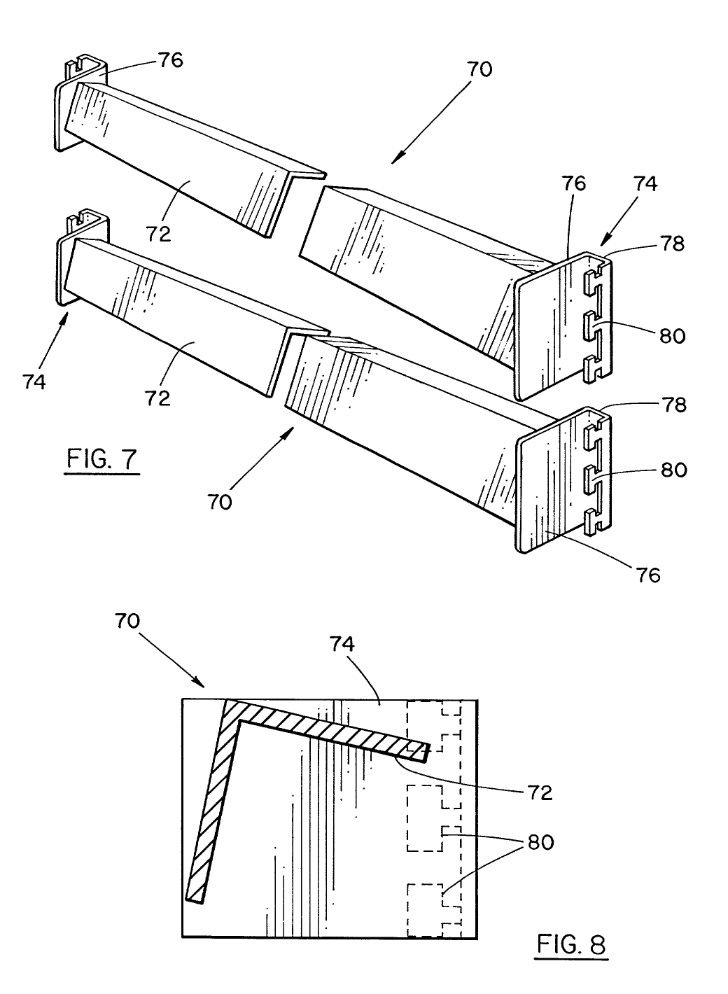

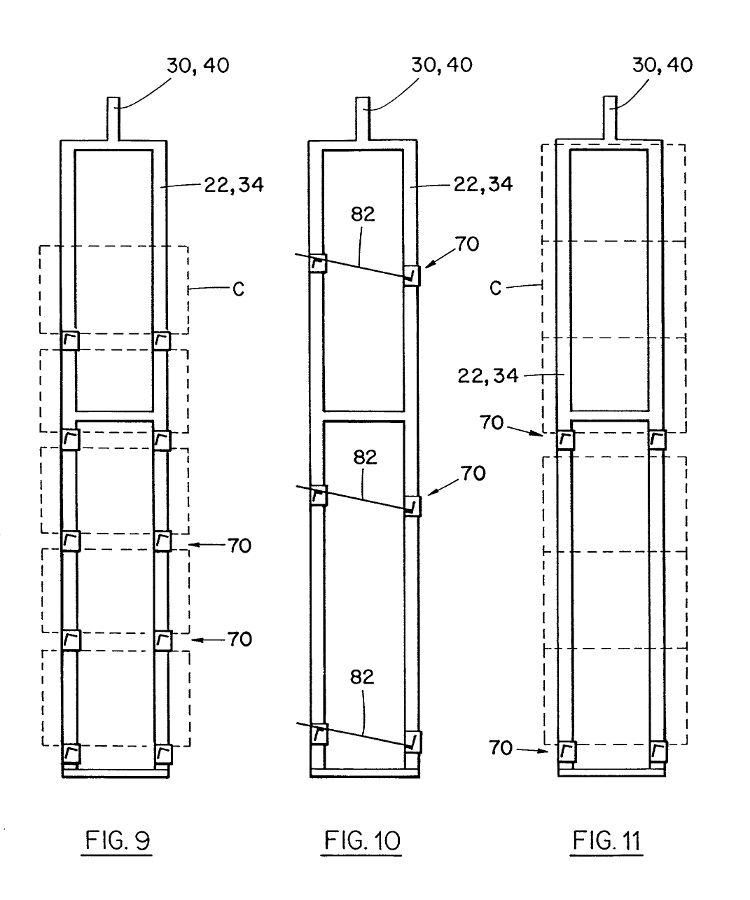

The bars 70 can be used with the apex of the L-shaped structural steel angle stock 72 directed upwardly. The use of such shelf bars 70 is illustrated in FIGS. 9, 10 and 11.

FIG. 9 shows product on such shelf bars. Usually product stored in inventory will be contained in cases. Thus, FIGS. 9, 10 and 11 all show individual cases C.

FIG. 9 shows such cases supported horizontally in spaced apart location. Alternatively by simply reversing the forward one of the bars 70, by changing it end for end, it can be used with the apex of the structural steel angle stock directed downwardly (FIG. 10).

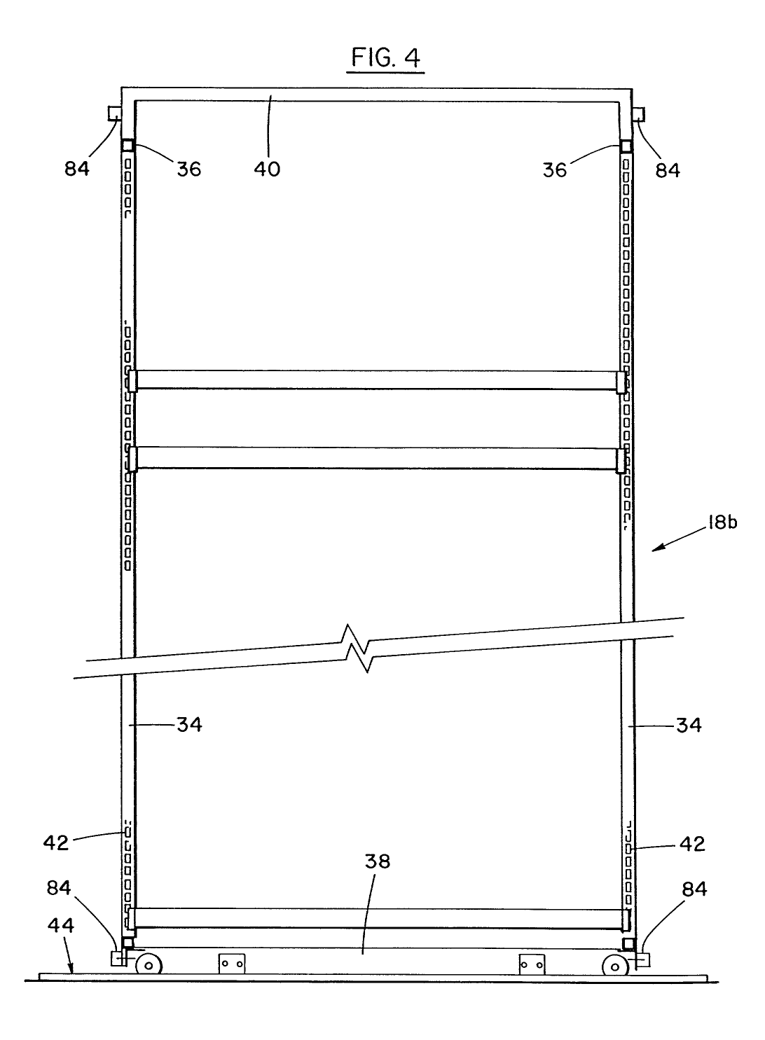

In this case, a planar shelf platform 82, having an edge flange 84, can be placed between the rear and front bars 70. Assuming the front bar 70 has been reversed as shown in FIG. 10, the platform 82 will then rest at a forward tilted angle, as shown. Cases of product can then be supported at an angle if desired. In this case, product can be removed from cases and can be placed directly on such platforms, if desired.

Where bulk storage of cases of product is required, then fewer bars 70 are used. Bulk storage of cases C is illustrated in FIG. 11. Preferably, bumper pads 84 are secured on the ends of the sliding shelves 18A, 18b, (FIG. 4).

As will be understood these various different systems of bars is not exhaustive of all possibilities. Customers may require the design of special forms of such bars or other types of shelves, to suit particular types of product in ways other than those examples given above.

For example, storage trays formed of wire baskets (not shown), of a type well known in the art, may be secured between brackets similar to brackets 80 and can then be attached to the columns. This will provide for storage of greater quantities of loose product.

It will thus be seen that the invention provides an inventory storage shelving system providing for storage of large quantities of product. When used in a cold vault, all stored product will be stored chilled and will be readily accessible for restocking of the display racks. The invention provides a front set of moveable or sliding inventory shelves that is effective in construction and incorporates full safety features, and allows access to a rear set of fixed inventory shelves. The various different arrangements of shelf bars provide for a range of different needs of the storeowner, and is fully flexible to allow the store personnel to rearrange the shelving to suit a range of different needs.

The invention also provides a cold storage vault providing the two functions of displaying chilled product for sale, and maintaining a substantial inventory of chilled product readily accessible for restocking the display.

The foregoing is a description of a preferred embodiment of the invention, which is given here by way of example only. The invention is not to be taken as limited to any of the specific features as described, but comprehends all such variations thereof as come within the scope of the appended claims.

The present invention having been thus described with particular reference to the preferred forms thereof, it will be obvious that various changes and modifications may be made therein without departing from the spirit and scope of the present invention as defined in the appended claims.

What is claimed is:

1. A space saving shelving system for storage of product in a confined space providing ready access to said product for transfer of said product from said shelving to another location comprising;
a first shelf support frame having at least four stationary upright columns, arranged in pairs of respective stationary front and rear columns, said first shelf support frame being adapted to be secured in a predetermined location within said confined space;
horizontal stationary frame bars extending between said stationary front and rear columns in each said pair;
transverse stationary frame bars extending between said stationary front columns and between said stationary rear columns, said front and rear columns and said horizontal bars and said transverse bars defining together a generally rectangular storage space;
at least two moveable second shelf support frame, adapted to be located closely spaced from and parallel to said first support frame, each of said at least two second support frames having two pairs of respective second front and rear columns;
horizontal second frame bars extending between said respective second front and rear columns;
transverse second frame bars extending between said second front columns and said second rear columns;
first shelf bars dimensioned to extend between said first stationary front and rear columns, and second shelf bars dimensioned to extend between said second front and rear columns of said sliding shelves; and,
attachment devices secured at opposite ends of said first and said second shelf bars.

2. The space saving shelving system of claim 1, wherein said confined space is a cold vault for cold storage of said product, said cold vault having at least one wall, and wherein said first shelving is located against said at least one wall of said cold vault.

3. The space saving shelving system of claim 2, wherein said second shelving is located closely spaced from said first shelving, and wherein movement of said second shelving giving access to said first shelving.

4. The space saving shelving system of claim 1, wherein said first columns and said second columns are formed with slots at spaced intervals, said attachment devices being interengageable with said slots.

5. The space saving shelving system of claim 4, wherein said brackets on said shelf bars comprise face flanges located to abut on said first and second columns and fingers spaced from said face flanges for interengagement with said slots.

6. The space saving shelving system of claim 5, further comprising angle portions extending between said face flanges and said fingers.

7. The space saving shelving system of claim 6, further comprising a track for said second shelf support frames and fastening devices for securing said track to a substrate, and gliders on said second shelf support frames received on said track for permitting movement of said second shelf support frames along said track to give access to said first shelf support frame.

8. The space saving shelving system of claim 7, wherein said track includes spaced apart front and rear grooves and wherein said gliders include front and rear rollers on said second shelf support frames for rolling in respective said grooves.

9. The space saving shelving system of claim 8, further comprising anti-friction pads in said grooves.

10. The space saving shelving system of claim 9, further comprising anti-tipping devices on said track, and anti-tipping members on said inventory shelf support frames, said anti-tipping devices and said anti-tipping members being interengageable with one another to prevent tipping of said second shelf support frames.

11. A cold storage vault for storing products at reduced temperatures, having a sales area with display racks accessible for removal of product for purchase, and having storage area for cold storage of additional inventory of said product, said cold storage vault comprising:
two or more vault walls defining said cold storage vault, at least one of said walls having a service door for access to said storage area, and another of said walls having at least one sales access door;
a space saving shelving system for storage of product located in said storage area of said cold vault providing ready access to such product for transfer of product from said shelving to another location, said space saving shelving system comprising:
a first shelf support frame having at least four first upright columns, arranged in pairs of respective first front and rear columns, said first shelf support frame being adapted to be secured in a predetermined location within said confined space;
horizontal first frame bars extending between said first front and rear columns in each said first pair;
transverse first frame bars extending between said first front columns and between said first rear columns, said first front and rear columns and said horizontal bars and said transverse bars defining together a generally rectangular first storage space;
at least two second shelf support frames adapted to be located closely spaced from and parallel to said first support frame, each of said at least two second support frames comprising two pairs of respective second front and rear columns;
horizontal second frame bars extending between respective second front and rear columns;
transverse second frame bars extending between said second front columns and said second rear columns;
first shelf bars dimensioned to extend between said first front and rear columns, and second shelf bars dimensioned to extend between said second front and rear columns; and,
attachment devices secured at opposite ends of said first and said second shelf bars interengageable with said first and second columns.

12. The cold storage vault of claim 11, wherein said first front and rear columns and said second front and rear columns are formed with slots at spaced intervals, said attachment devices being intergageable with said slots.

13. The cold storage vault of claim 12, wherein said attachment devices comprise brackets on said shelf bars having face flanges located to abut on said first front and rear column and said second front and rear column and fingers spaced from said face flanges for interengagement with said slots.

14. The cold storage vault of claim 13, further comprising angle portions extending between said face flanges and said fingers.

15. The cold storage vault of claim 14, further comprising a track for said second shelf support frames and fastening devices for securing said track to a substrate, and gliders on said second shelf support frames received on said track for permitting movement of said second shelf support frames along said track to give access to said first shelf support frame.

16. The cold storage vault of claim 15, wherein said track includes spaced apart front and rear grooves, and wherein said gliders include front and rear rollers on said second shelf support frames for rolling in respective said front and rear grooves.

17. The cold storage vault of claim 16, further comprising anti-friction pads in said grooves.

18. The cold storage vault of claim 17, further comprising anti-tipping devices on said track, and anti-tipping members on said second shelf support frames, said anti-tipping devices and said anti-tipping members being interengageable with one another to prevent tipping of said second shelf support frames.
